(19) United States
(12) Patent Application Publication
(10) Pub. No.: US 2009/0146439 A1
(43) Pub. Date: Jun. 11, 2009

(54) IRONMONGERY

(75) Inventors: John Russell Watts, Alberta Park (AU); David John Greenbury, St. Kilda (AU)

Correspondence Address: SUGHRUE MION, PLLC, 2100 PENNSYLVANIA AVENUE, N.W., SUITE 800, WASHINGTON, DC, 20037, US

(73) Assignee: WATTS HARDWARE MANUFACTURING PTY LTD, South Melbourne, VIC (AU)

(21) Appl. No.: 12/090,577

(22) PCT Filed: Oct. 17, 2006
(86) PCT No.: PCT/AU2006/001532

§ 371 Date: Sep. 12, 2008

(30) Foreign Application Priority Data
Oct. 21, 2005 (AU) 2005906623
Oct. 24, 2005 (AU) 2005906630

(51) Int. Cl. E05B 3/04

(52) U.S. Cl. 292/350; 292/348

(57) ABSTRACT

A handle assembly including a base (3), a resilient member (18), a cup (31) restrained relative to the base, a washer (19) and a handle (1) supported relative to the base (3) and characterized by a first undisplaced disposition relative to the base, the washer and handle connected to be angularly displaceable together from the undisplaced disposition against biasing derived from the resilient member acting simultaneously on the cup and washer, the cup releasable relative to the base to enable the handle, washer and resilient member to be rotated together to a different undisplaced configuration.

### BACKGROUND AND UNRESOLVED NEEDS

The inventions within address, amongst other issues, an age-old problem with ironmongery (and in particular with door furniture) of having to reverse handles and/or replace the handle from one handle assembly with the handle of another handle assembly to render the handles suitable for doors having hinges on the opposite side or sliding in the opposite direction.

Although others have described methods of executing the re-handing such as removing circlips and configuring the handles assemblies to have handles attached to removable block, none of the methods employed or described to date is elegant nor provides the functionality provided by the inventions within.

The inventions within also address a common deficiency of only supporting a handle shaft adjacent to the aperture in the back-plate through which it extends—this common method of construction leaving handle assemblies susceptible to failure characterized by circlips being dislodged.

### SUMMARY OF THE INVENTION

According to one aspect of the invention, there is an handle assembly including a base, a resilient member, a cup restrained relative to the base, a washer and a handle supported relative to the base and characterized by a first undisplaced disposition relative to the base,

the washer and handle connected to be angularly displaceable together from the undisplaced disposition against biasing derived from the resilient member acting simultaneously on the cup and washer,

the cup releasable relative to the base to enable the handle, washer and resilient member to be rotated together to a different undisplaced configuration.

In a second aspect of the invention, wherein the cup acts to restrain the handle to displace angularly about its pivotal axis.

In a third aspect of the invention, the handle and washer mesh by means of at least one protrusion meshing within a recess.

In a fourth aspect of the invention, the handle includes a shank that extends through a circular aperture in the base, said shank having at least one sideways extending coupling shoulder to mesh within a corresponding recess within the washer to angularly couple the washer and shank.

In a fifth aspect of the invention, there is a locking blade and screw wherein the screw can be applied to the base to urge the locking blade against the cup to urge the cup towards the base to restrain the cup against rotation.

In a sixth aspect of the invention, the handle includes a shank extending through a circular aperture in the base and having at least one sideways extending retaining shoulder that overlaps the periphery of the circular aperture during normal operation to retain the handle attached to the base.

In a seventh aspect of the invention, the aperture includes a corresponding outward aperture extension for each retaining shoulder, said aperture extensions configured to simultaneously provide passage for each retaining shoulder as the shank is displaced through the circular aperture during assembly of the handle assembly.

In an eighth aspect of the invention, the handle comprises an unlatching lever and the base comprises a back-plate,

the unlatching lever being removable from the back-plate by releasing the cup to enable the lever to be displaced from its normal operating range to bring each retaining shoulder into alignment with its corresponding aperture extension and to subsequently be displaced axially away from the back-plate.

In a ninth aspect of the invention, each coupling shoulder is configured as a retaining shoulder.

In a tenth aspect of the invention, the handle is displaceable in both angular directions.

In an eleventh aspect of the invention, there are multiple shoulders and outward extensions.

In a twelfth aspect of the invention, the handle, spring, washer and cup can be assembled to the base without the use of tools.

In a thirteenth aspect of the invention, the handle includes an axial recess to receive a drive shaft connected to locking means.

According to another aspect of the invention there is an handle assembly substantially as described herein with reference to and as illustrated in the accompanying drawings

The elements relating to the various aspects of the invention claimed within are identified within the specification as follows and where unless the context requires otherwise:
“Locks” or variations such as “lock” will be understood to include complete locks for displaceable wings and improvements for locks for displaceable wings that are transportable into other locks and locking devices without being limited to the complete locks described herein.
“Comprise” or variations such as “comprises” or “comprising” will be understood to imply the inclusion of a stated integer or group of integers but not the exclusion of any other integer or group of integers.
Positional prepositions such as “rear” and “forward” are used to assist in description of the preferred embodiments and with reference to the accompanying drawings and have in general no absolute significance and “overlap” and derivations such as “overlaps” implies at least in-part, occupying a same plane as.
Headings are included for convenience only and not to affect on interpretation.
“Preferably” or variations such as “prefer” does not imply that the form of an integer is restricted to that referred to as preferred unless the context requires otherwise, “preferred” implies acceptable and if need be, able to perform a function required by the inventions in which it is included.
“Wing” embraces both “doors” and “windows”
“Member” is an identifiable entity that may include one or more identifiable components.
“Aperture” and “recess” in general embrace a hole that extends from a surface while “aperture” in some contexts implies a hole that extends between surfaces.
“Furniture” includes “door furniture” that includes a “handle assembly”.
“Handle assembly” includes a “handle” supported by a “base” that in one form comprises an “unlatching lever” supported by a “back-plate”.
“Handle” includes a knob, lever and an “unlatching lever”.
“Unlatching lever” includes a lever or knob that is hand operable to cause an “engaging member” to become unlatched.
“Base” includes a “rose” that may include a surface mounted member having a recess on the underside.
“Back-plate” (or “back-plate”) includes a surface mounted box-like member having a recess on the underside.
“Engaging member” in isolated use, is a member displaceable between a fully displaced disposition and a fully retracted disposition. When employed with an “engagable member”, the engaging member is displaceable between an operative disposition (in which the engaging member finds itself when engaged with the engagable member) and an inoperative disposition removed from the said engagement. Within this specification, fully displaced will embrace the operative disposition and retracted disposition will embrace the inoperative disposition.
“Latching” implies displacement of an “engaging member” into engagement with an “engageable member” under the action of biasing means.
“Latch-bolt” or “latch bolt” is an outwardly biased bolt capable of executing (or participating in) latching and includes bolts having a leading end that is chamfered or otherwise profiled on one or both sides.
“Auxiliary bolt” is an outwardly biased plunger that is operably associated with a latch bolt.
“Unlatching” means withdrawal of the engaging member from engagement.
“Locking” means the act of configuring the lock to restrain it from being unlatched and in some forms of locks employing deadlocking slides, it means restraining the deadlocking slide to restrain the bolt from being inwardly displaced in response to operation of the unlatching lever.
“French Door” means a door including a frame and a glass in-fill.
“Screen door” means a door including a frame and an insect restraining in-fill such as fiberglass mesh, woven mesh or perforated metal mesh,
“Lock body” includes an engaging member and a lock casing.
“Mortise lock” means a lock including a lock body, a strike plate, a pair of handle assemblies and a cylinder where the lock body is configured to be fitted within the frame of the wing.
“Single cylinder” means a substantially conventional lock cylinder comprising a separate subassembly that includes a key operable barrel within a cylinder housing.
“Double-cylinder” comprises a substantially conventional double lock cylinder comprising a separate subassembly that includes opposed coaxially supported barrels each operably connected to the same angularly displaceable “first cam” having a “first cam arm” characterized by a “free end” that extends radially to a “peripheral surface” defined in part by a common radial distance from the first cam pivotal axis.
“Free rotation single cylinder” includes a barrel operably connected with free movement to a first cam to enable the first cam to be displaced by the barrel from an undisplaced disposition to a displaced disposition and subsequently reversed to the undisplaced position enabling key removal; a “free rotation-double-cylinder” is configured such that each barrel is connected with free movement to the same first cam such that the cam is free (between limits) to be angularly displaced while the barrels remain undisplaced. This type of cylinder is commonly used in security door locks in Australia to enable the cam to be displaced by either barrel to a locking configuration and then the barrel to be reverse rotated to the undisplaced position enabling key removal while leaving the first cam in the locking position. In some forms of clutched and free rotation cylinders, one barrel is replaced by a hand operable turn knob; in some cylinders the cylinder housing comprises part of the handle back-plate.
“Set of locks” or a “lock series” includes locks constructed from a set of common components types.
Patent Specification shall be taken to include: a Body [comprising a Title, a Description of Preferred Embodiment/s, an Abstract and a Summary of the Invention] and Claims.

The elements relating to the various aspects of the current invention claimed within and other elements described within may also be employed within other inventions subject of divisional applications.

### DESCRIPTION OF THE PREFERRED EMBODIMENTS

### Description of the Figures

Embodiments of the present invention will now be described by way of example only with reference to the accompanying drawings in which:

FIG. 1 is an isometric view of the underside of a handle assembly with a shaft attached,

FIG. 2 is an exploded isometric view of the handle assembly of FIG. 1,

FIG. 3 is the handle assembly of FIG. 2 re-configured to have the undisplaced configuration disposed 90 degrees from the undisplaced configuration shown in FIG. 2,

FIG. 4 is an enlarged partial side view of the underside of the handle assembly of FIG. 3,

FIG. 5 is an enlarged schematic partial side view of the underside of the handle assembly being reconfigured with the cup (except for the stop shoulder omitted for convenience),

FIG. 6 is an enlarged schematic partial side view of the underside of the handle assembly of FIG. 3 (except for the stop shoulder omitted for convenience),

FIG. 7 is sectional view AA relative to FIG. 6,

FIG. 8 is an enlarged partial side view of the underside of an alternative handle assembly,

FIG. 9 is a schematic partial isometric view of a different embodiment of the washer, spring and shank and stop shoulder

FIG. 10 is a schematic partial isometric view of a different embodiment of the washer, spring and shank and stop shoulder.

Many common locks include a pair of handle assemblies configured as interior handle assembly that includes an interior lever and an interior base (and that may have apertures to receive and provide passage for the fixing screws) and an exterior handle assembly that includes an exterior lever an exterior base (and that may include horizontally elongated substantially cylindrical fixing bosses each with a coaxial screw recess configured to receive the threaded ends of the fixing screw). Alternatively, both the interior and exterior bases may have apertures to receive and provide passage for the fixing screws. The interior base may also support an interior locking lever such as that described in a co-pending Australian application 2005218038. Handle assemblies connected by screws as described above and/or having an interior locking lever and/or having levers that are not mirror images about a horizontal plane (and there is a “right-way” up) are “handed” and need to be configured to suit the handing of the wing to which they will be attached (be left hand or right hand)—hence, for convenience, they should be easily reconfigurable.

Where handle manufacturers, offer combinations of different levers and different bases, the inventory may be large. The inventions herein (amongst other things) provide a convenient and simple means of attaching levers to bases so that handles, knobs, back-plates and roses can be displayed and sold separately, to be assembled at a later time.

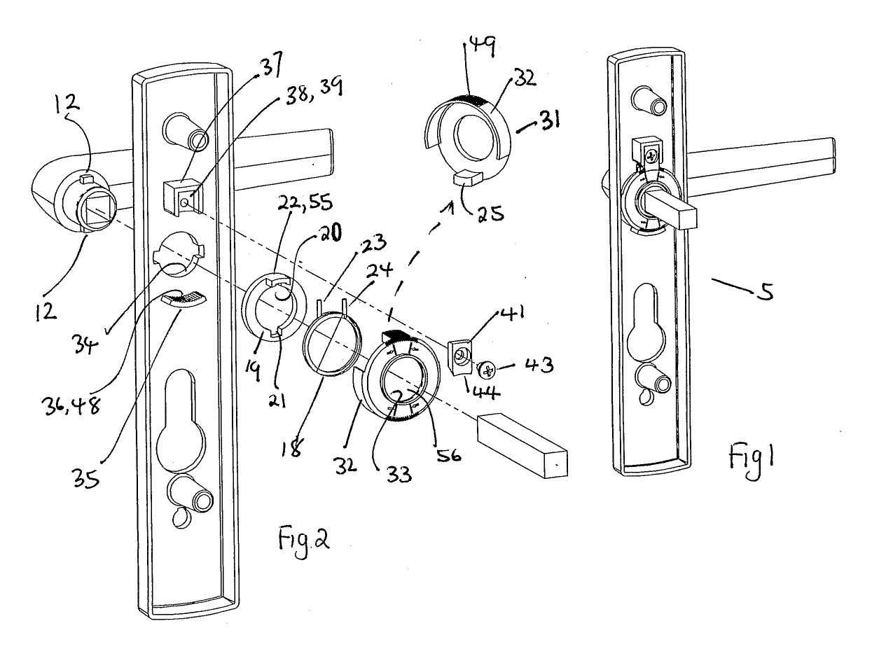

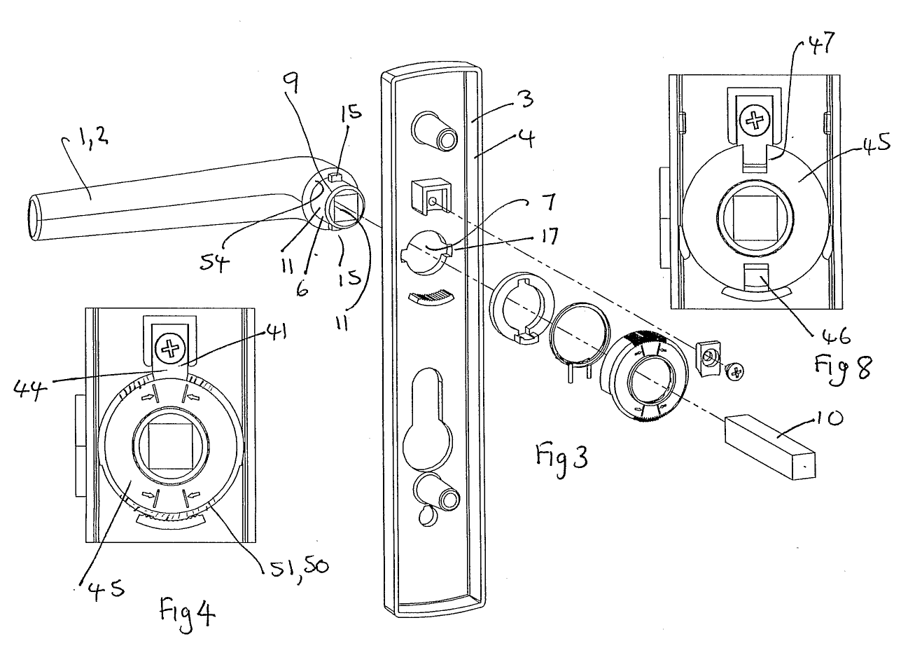

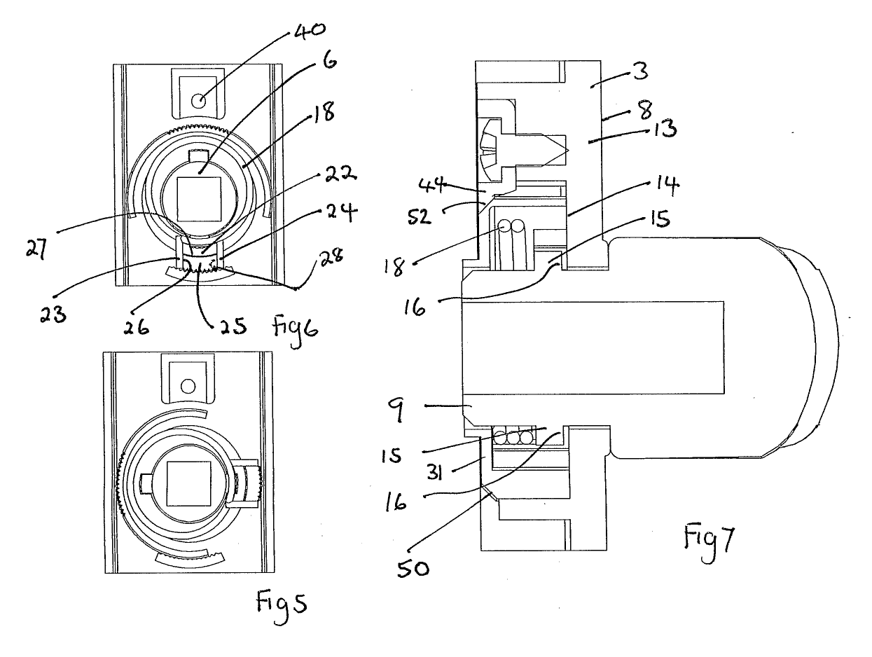

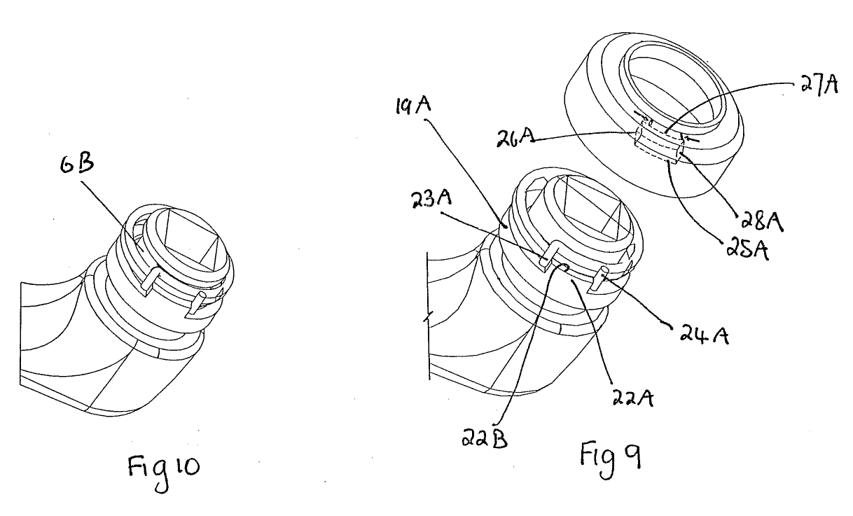

The inventions described herein are described in relation to a handle assembly as shown in FIG. 4, comprising a handle 1 that may comprise an operable unlatching lever 2 that is supported by a base 3 that may comprise a back-plate 4 to comprise the handle assembly 5 shown in FIG. 1, the inventions being particularly relevant to a handle configured as an unlatching lever supported in a back plate. The inventions described herein are not restricted to this form however and embrace the configurations described in the Definitions.

Handles subject of the inventions herein, include a cylindrical shank 6 that extend through a circular aperture 7 of the base shown in FIG. 7, that extends from the outer surface 8 of the base. The shank 6 may extend from a bearing surface 54 of the handle (preferably configured as an orthogonal face) of larger diameter to a remote end 9 furthest from hand engageable portion. Commonly, the remote end 9 would include a peripheral recess (not shown) configured to receive an external circlip but the inventions herein eliminate the use of a circlip.

In some handle assemblies (not subject of the inventions herein), a cylindrical support boss having a cylindrical bore extends from the underside of the base to comprise a peripheral support sleeve to better support the shank 6 by, in effect, providing annular bearing surfaces spaced along the bore one adjacent to each end of the bore. One can better appreciate the better support by considering an alternative, inferior design where the shank is supported only by the side of the aperture 7. In general, the further apart the effective annular bearing surfaces are, the smaller will be the forces applied to the wall of the bore by the shaft in response to the handle operation and the lower will be the friction. The inventions herein, provide comparable support to that provided by a support boss.

In some forms, the handle is operably connected to a lock mechanism by a shaft 10 that mates within an axially elongated recess 11 within the shank; in one common form, the shaft comprises a shaft of substantially square cross-section that mates within a shaft recess in the handle that also has a substantially square cross-section.

In some embodiments, the base 3 is configured as a conventional hollow base (having a hollow portion) that may be configured as a back-plate 4 or a rose, the hollow base being defined in-part, by an outer wall 13 as shown in FIG. 7, bounded on one side by the outer surface 8 and on the other side by an internal surface 14 that also defines in-part the extent of the hollow portion within the underside.

In some forms, shanks include a retaining shoulder 15 and (preferably two opposed retaining shoulders) that extends radially outwardly from the outer cylindrical face of the shank 6 as shown in FIG. 7—each shoulder being longitudinally disposed along the shank such that a surface thereof (disposed furthest from the remote end 9) acts as a bearing surface 16 lies in a plane parallel and adjacent to the plane which defines the adjacent internal surface 14, this configuration enabling the bearing surface 16 to slide over the internal surface 14 with working clearance. For each retaining shoulder 15, the aperture 7 has a corresponding slotted aperture 17 that extends radially outwardly from its periphery, the slotted apertures 17 are configured to allow all retaining shoulders simultaneous passage through their associated slotted aperture. The retaining shoulders and slotted apertures are further configured to be angularly disposed such that the retaining shoulders and slotted apertures never become aligned when the handle is within its normal operating range—so in normal use, the handle cannot become detached from the base. In some forms, the shank is retained attached to the base by means such as the circlip described below that may be applied to the shank on the external side of the cup described below.

In some forms, the handle is biased towards an undisplaced angular disposition relative to the base (that may in common usage, correspond to a fully extended latch bolt of a lock body operably connected to the handle by the shaft 10) by a resilient means that may take the form of a torsion spring 18 in cooperation with a substantially laminar washer 19 defined in-part, by opposed surfaces that lie in planes orthogonal to the axis of the shaft (and that is preferably substantially circular in form); the torsion spring having a longitudinal axis substantially parallel with that of the shank.

In some forms (not shown, not preferred but embraced by the inventions) the shank and washer are angularly coupled by dint of the shank including at least one peripheral slotted channel that extends from the remote end 9 towards the bearing surface 8A and having an axis parallel that of the shank and for each slotted channel, the washer includes an associated protruding shoulder for each slotted channel that extend substantially radially inwardly from an axial aperture 20 (through which the shaft extends) to occupy a slotted channel to mate without free movement whereby to angularly couple the washer to the shank.

In other forms (where the washer 19 includes a washer aperture 20 through which the shank 6 extends), the shaft 6 includes at least one coupling shoulder (that extends radially outwardly from the outer cylindrical face of its shank) and for each coupling shoulder 12, the washer 19 has a corresponding slotted recess 21 that extends radially outwardly from the periphery of the washer aperture; the washer being configured to enable all such coupling shoulders 12 to simultaneous have passage to their associated slotted recess 21 to occupy their associated slotted recesses 21 in the assembled handle whereby to operably couple the washer to the shank.

In some forms, the retaining shoulders 15 also comprise coupling shoulders 12 and the handle includes a pair of such shoulders as shown in the figures.

The washer 19, subject of the inventions herein, includes a return portion 55 that in some forms comprising a fin 22 while the torsion spring 18 includes a first spring arm 23 that extends to overlap the fin 22 to be engageable with or by the fin as shown in FIG. 6. In some forms, the return portion 22 is configured as an elongated fin defined in part by a longitudinal axis parallel but disposed from the pivotal axis of the handle while the spring arms are disposed to extend substantially radially relative to the pivotal axis). The torsion spring includes a second second spring arm 24 that extends to overlaps the fin 22 on the other side to be engageable with or by the fin. The spring arms 23 and 24 extend further to overlap an elongated stop shoulder 25 that extends in a direction parallel the axis of the shank and adjacent to the fin (when the fin is undisplaced). In some forms, the first spring arm abuts first side 26 of the stop shoulder 25 and fin 22 as shown in FIG. 6, while the adjacent portion of the torsion spring extends across the inside face 27 of the fin 22 while the second spring arm 24 abuts the other sides 28 of the stop shoulder 25 and fin 22 to similarly extends across the inside face 27 of the fin.

Once assembled, the stop shoulder 25 is pressed on from both sides by the arms of the spring while the fin 22 extends between the spring arms and between the shank and the stop shoulder. The fin can be displaced in a first direction to displace the first spring arm to be biased against displacement (while the second spring arm is left pressing against the side of the stop shoulder) and the fin can be displaced in the opposite direction to displace the second spring arm to be biased against displacement (while the first spring arm is left pressing against the side of the stop shoulder); the assembly characterized by an undisplaced configuration where the fin is adjacent to the stop shoulder and the spring arms extend beside both the stop shoulder and fin. In some forms, the first spring arm simultaneously abuts the same side of both the stop shoulder and fin and the second spring arm simultaneously abuts the other side of both the stop shoulder so that any angular displacement of the handle from the undisplaced disposition is gives rise to a torque opposing the displacement. In some embodiments, the stop shoulder 25 comprises a blade like extension to a separate member 30 that is attached relative to the base and within the hollow portion. The member 30 may comprise a substantially cylindrical hollow cup-like member referred to herein as a cup 31.

In some forms, the cup includes a substantially laminar side 32 defined in-part by an outer diameter D that includes a circular aperture 56 coaxial with that of the aperture 7 and having a diameter substantially the same as that portion of the shank that extends through aperture 33A. Aperture 56 in effect providing an annular bearing surface 33 for the shank adjacent to the remote end 9 of the shank and longitudinally spaced from the annular bearing surface 34 comprising the wall of the aperture 7, to provide improved support for the handle as shown in FIG. 7. The washer 19 and cup 31 are preferably further configured to have only working clearance between the two so that when the shank is removed, the aperture in the washer remains substantially coaxial with the aperture of the base.

When the cup is unrestrained, the cup, torsion spring, washer and the handle of the inventions within, can all be rotated (relative to the base) together to enable a handle that protrudes from one side of the base to be reconfigured to protrude from the other side (to effect rehanding of the handle assembly).

The handle assembly is subject to a number of design constraints being:
a) the distance the arms extend is limited by the need to properly engage the stop shoulder and cannot simply be reduced to satisfy just the requirement stated above.
b) the effective diameter of the spring reduces as it is compressed during handle operation thus requiring clearance between the shank and the spring (in the form it assumes when the handle is undisplaced) to accommodate this reduction.

The invention addresses these issues simultaneously by a) locating the spring between the fin 22 and shank 6 so that it abuts one or the other and is closely disposed to both as shown in FIG. 3 and so the clearance between the spring and shank increases according to the distance the part of the spring is from the fin (i.e. the axis of the spring is offset from the axis of the shank) and b) configuring the stop shoulder to closely disposed to the shank when the handle is undisplaced so that the spring arms can have a minimum length. This configuration enables the arms of the spring to swing upwardly or downwardly as the assembly is reconfigured even when the base is a narrow back-plate.

In other forms as shown in FIG. 9, the washer 19A has a right angled return portion comprising a fin 22A that extends in a direction parallel the axis of the shank to an orthogonal plane 22B within the length embracing the coils of the spring and that is occupied by an end face of the fin 22A (this plane preferably defining the centre of the spring from which the spring extends equal lengths in opposite directions). The torsion spring has: a) a substantially longitudinally extending first spring arm 23A that overlaps the fin 22A to be engageable with or by the fin 22A—the first spring arm comprising an end portion of the spring that extends from a last coil to pass over the outside of the coils to extend towards the washer 19A in a direction parallel the axis of the shank and by doing so, overlapping the adjacent stop shoulder 25A to overlap the fin 22A protruding from the washer, and b) a substantially longitudinally extending second spring arm 24A that overlaps the fin 22A to be engageable with or by the fin—the second spring arm comprising an end portion of the spring that extends from a last coil to pass over the outside of the coils to extend away from the washer in a direction parallel the axis of the shank and by doing so, overlapping the adjacent fin 22A to overlap the stop shoulder 25A. In this form, the stop shoulder 25A comprises a right-angled return portion that extends towards the fin 22A in a direction parallel the axis of the shank to (or adjacently to with working clearance) the orthogonal plane 22B, to be opposed and adjacent to the fin when the handle is undisplaced. In some forms, the first spring arm abuts first sides 26A of the stop shoulder and fin while the adjacent portion of the spring extends across the inside face 27A of the fin and the second spring arm abuts the other sides 28A of the stop shoulder and fin to similarly extends across the inside face 27 of the fin. In this form, the spring is in-part between the inside face 27A of the fin 22A and shank 6 and in-part between the inside face 27A of the stop shoulder 25A and shank 6 to be closely disposed to the shank, fin and stop shoulder. The axis of the spring is offset from the axis of the shank so that the clearance between the spring and shank is configured to increase according to the distance the spring portion is from the shank. This form is particularly relevant to handles having a narrow back-plate because the arms can be configured to protrude only a small distance from the side of the spring a distance that may comprise little more than spring wire diameter. This form may be further configured to have a shank 6B of reduced diameter adjacent to the spring as shown in FIG. 10 whereby to enable the spring to correspondingly have a reduced the diameter.

The shank and washer may be are angularly coupled by dint of peripheral slotted channels in the shank extending occupied by associated protruding shoulder of the washer as described above or by protruding retaining shoulders that occupy recesses in the washer as described above (none of these being shown in FIG. 9). Once assembled, any angular displacement of the handle from the undisplaced disposition is gives rise to a torque opposing the displacement—as described above in relation to the earlier form of washer and cup.

The inventions within, require the cup to be releasably restrained against rotation relative to the base 3 and where the cup includes an aperture 33A through which the shank 6 extends to be supported, the cup is required to exert a reaction capable of restraining the shank end 9 against translation relative to the to base, in which case, the cup itself must be restrained against translation. In some such forms, the base includes an annular fin-like locating shoulder 35 that may comprise a projection from the internal surface 14 of the base, this locating shoulder 35 including a substantially cylindrical locating face 36 that faces towards the substantially cup-like member 31, the locating surface 36 being defined in-part by an axis coaxial with that of the shank and by a radius of D/2 (D being the radius of the adjacent shank); the locating face disposed such that in the assembly the locating face 36 abuts the substantially cup 31 to support the cup and help maintain it correctly disposed. Opposite this, a protruding profiled shoulder 37 provides a substantially rectangular pocket 38 having a floor 39 (defined by a plane orthogonal to the axis of the shank) from which a screw recess 40 extends towards the internal surface 14—and in some forms the profiled shoulder comprises a protrusion from the internal surface 14. The pocket 36 is occupied by a locking blade 41 that extends towards the locating face 35 to abut a side of the cup as shown in FIG. 4 to retain the cup urged towards and abutting the locating face 35; the locking blade including a screw aperture 42 through which a fixing screw 43 has passage and by which the locking blade is retained in the pocket. The locking blade and pocket 36 may be further configured so that a leading end 44 extends to overlap the cup to restrain the cuplike member urged against the internal surface 14. In one form this leading end 44 comprises an angled protrusion as shown in FIG. 4.

In some forms, the substantially planar, circular rear surface 45 of the cup as shown in FIG. 8, has at its periphery a peripheral pocket 46 with side walls 47 (that are substantially orthogonal to the rear surface) and the leading end protrudes into this peripheral pocket to abut the sides to restrain the cup against angular displacement. The cup may include a pair of opposed peripheral pockets to enable the cup and associated part to be rotated to reconfigure the assembly to suit opposite handed hinged doors as described above.

In other forms, the locating face has a textured surface 48 comprising teeth, small shoulders or another form of surface interruption that extend orthogonally from the internal surface 14 and the side surface 32 of the cup is similarly textured 49 such that when the textured surfaces are urged together they mate (at least to the extent) that they resist rotation of the cup.

In some forms, the rear surface 45 and the cup side 32 are connected by a chamfered portion 50 having a textured surface 51 as shown in FIG. 4, comprising surface teeth, small shoulders or another form of surface interruption and the inside face 52 (FIG. 7) of the leading portion of the locking blade is similarly textured so that in the assembly, these faces mate to similarly resist rotation of the cup. This form enables the cup and hence handle in its undisplaced state, to be disposed at any required angle relative to the base 3.

In each case, the assembly is configured such that when the locking blade is removed, the cup and end 9 of the shank may be displaced away from the locating surface so that the surfaces do not mate to restrain displacement, this displacement being accommodated by the operating clearances between the shank and aperture 7 and between other meshing parts.

During one method of assembly, the retaining shoulders 15 of the shank 6 and the slotted aperture 17 of the base 3 are aligned, the shank is inserted into the aperture 7 and rotated to retain the handle attached to the base 3; the washer is then assembled to the shank with its aperture coaxial with that of the axis of the shank and so its slotted apertures become aligned with the retaining shoulders, the spring washer is then axially applied to the shank with the arms of the torsion spring held apart so as to have one arm on each side of the fin of the fin of the washer and the cup-like member is then axially applied so that the shank extends into its aperture while its periphery abuts the locating face. The cuplike member is then orientated by rotation till the handle extends at the required angle from the base; the locking screw is inserted and tightened.

In the assembly, the torsion spring is sandwiched between the washer and cup as shown in FIG. 7 to be retained substantially orthogonally to the shank, this in turn acting to restrain the washer between the internal surface of the base and be retained substantially orthogonally to the shank—in some forms the torsion spring is configured to also acts as a compression spring urging the components on both sides away from each other and hence the washer against the base; in this case the spring has a natural height greater than the distance between base cup so that it becomes compressed during assembly.

Further, the handle may be removed from the assembly by rotating the cup so the slotted apertures of the base and washer simultaneously become aligned with the retaining shoulder, at which point the shank can be withdrawn axially from the base (while the aperture in the washer remains aligned with that of the base) to enable the or a different handle to be subsequently assembled.

The base and handles described within may both be manufactured as single castings by conventional die-casting methods requiring only surface finishing to become finished handles. The base may similarly be manufactured by hot forging requiring only minimum machining and surface finishing to become a finished component. The handle may substantially be manufactured by hot forging but may require a separate shank to be assembled to an axial recess in the handle. This shank may include retaining shoulders comprised of separate elongated members that extend in one direction (substantially radially) from each side of the shank and in the other direction, into apertures in side of the shank; they may comprise cylindrical members machined to include planar the bearing surfaces 16.

1. A handle assembly including a base, a resilient member, a cup restrained relative to the base, a washer and a handle supported relative to the base and characterized by a first undisplaced disposition relative to the base,
the washer and handle connected to be angularly displaceable together from the undisplaced disposition against biasing derived from the resilient member acting simultaneously on the cup and washer,
the cup releasable relative to the base to enable the handle, washer and resilient member to be rotated together to a different undisplaced configuration.

2. A handle assembly according to claim 1, wherein the cup acts to restrain the handle to displace angularly about its pivotal axis.

3. A handle assembly according to claim 1, wherein the handle and washer mesh by means of at least one protrusion meshing within a recess.

4. A handle assembly according to claim 3, wherein handle includes a shank that extends through a circular aperture in the base, said shank having at least one coupling shoulder to mesh within a corresponding recess within the washer to angularly couple the washer and shank.

5. A handle assembly according to claim 1, including a locking blade and screw wherein the screw can be applied to the base to urge the locking blade against the cup to urge the cup towards the base to restrain the cup against rotation.

6. A handle assembly according to claim 3, wherein the handle includes a shank extending through a circular aperture in the base and having at least one sideways extending retaining shoulder that overlaps the periphery of the circular aperture during normal operation to retain the handle attached to the base.

7. A handle assembly according to claim 6, wherein the aperture includes a corresponding outward aperture extension for each retaining shoulder, said aperture extensions configured to simultaneously provide passage for each retaining shoulder as the shank is displaced through the circular aperture during assembly of the handle assembly.

8. A handle assembly according to claim 7, wherein the handle comprises an unlatching lever and the base comprises a back-plate,
the unlatching lever being removable from the back-plate by releasing the cup to enable the lever to be displaced from its normal operating range to bring each retaining shoulder into alignment with its corresponding aperture extension and to subsequently be displaced axially away from the back-plate.

9. A handle assembly according to claim 3, wherein each coupling shoulder is configured as a retaining shoulder.

10. A handle assembly according to claim 1, wherein the handle is displaceable in both angular directions.

11. A handle assembly according to claim 4, wherein there are multiple shoulders and outward extensions.

12. A handle assembly according to claim 1, wherein the handle, spring, washer and cup can be assembled to the base without the use of tools.

13. A handle assembly according to claim 1, wherein the handle includes an axial recess to receive a drive shaft connected to locking means.

14. (canceled)
